(19) United States
(12) Patent Application Publication
(10) Pub. No.: US 2006/0185429 A1
(43) Pub. Date: Aug. 24, 2006

(54) An Intelligent Integrated Sensor Of Tire Pressure Monitoring System (TPMS)

(75) Inventors: Sheng Liu, Shanghai, MI (CN); Bin Chen, Canton, MI (US); Junjie Chen, Shanghai (CN); Zhiyin Gan, Shanghai (CN)

Correspondence Address: SHENG LIU, JUNJIA CHEN, BIN CHAN;FINEMEMS INC., RM 309, NO. 518 B, BIBO RD., ZHANGJIANG HI-TECH PARK, SHANGHAI, 201203, CN

(73) Assignee: FINEMEMS INC., Shanghai (CN)

(21) Appl. No.: 10/906,444

(22) Filed: Feb. 21, 2005

(51) Int. Cl. B60C 23/02

(52) U.S. Cl. 73/146.5

(57) ABSTRACT

A single integrated sensing chip with multi-functions for tire pressure monitor system (TPMS) comprises: a pressure sensor, an accelerometer, a temperature sensor, and an ASIC (Applied Specific Integrated Circuit) that implements signal conditioning and digitalizes pressure output. The accelerometer incorporated for vehicle motion is used to determine centrifugal acceleration or three-axial acceleration of the rotating wheel, and used for the TPMS sensor wake-up from “power down” mode, or when the velocity of the vehicle is higher than certain speed threshold, which is more robust and lower in cost than the mechanical vibration switch and is naturally integrated with the electronic control unit. The accelerometer can be used for regular motion sensing to monitor the dynamic stability. The integrated sensor system can be packaged into one plastic package first, and then surface mounted to the printed circuit board, or the multi-function single chip can be wafer bonded on the wafer level first and diced into many individual chips, with each chip being directly attached on to the printed circuit board by wire bonding or flip-chip assembly.

### BACKGROUND OF THE INVENTION

Prescribed by governmental regulations in USA, such as in 49 CFR Part 571, entitled “Federal Motor Vehicle Safety Standards: Tire Pressure Monitoring Systems; Controls and Displays”, direct sensing is an important component in TPMS. In order to protect the TPMS's components from the typically harsh corrosive, high temperature environment inside a tire, encapsulation is typical. Sensor will be subjected to relatively high accelerations that could stress joining interfaces and could result in reliability issues due to sensor disengaging from the tire rim. Smaller and more compact the sensor system is, the better the performance is. It is also easier to balance the additional mass by the transmitter sensor.

The present invention relates to an intelligent integrated multi-functional sensing system, more particularly, to a system that monitors the tire pressure, temperature, battery voltage, low frequency (LF) signal, and tire acceleration of a motor vehicle. The invention integrates pressure sensor, acceleration, temperature, and battery voltage, and in a single chip or multiple chips. The single chip or multiple chips are integrated with Application specific Integrated Circuit (ASIC) chip(s) by packaging into a plastic package or by mounting them all on the board. Low profile compact packaging can generate signals of tire pressure, temperature, level of battery voltage, low frequency for initial identification of each tire, and vibration switch by accelerometer. With the intelligent control of the system by ASIC, vehicle will be able to enhance its performance and safety.

Conventionally, the tire pressure monitoring system (TPMS) uses a pressure sensor and a temperature sensor mounted in a tire. The disadvantage of it is that the system cannot know whether the vehicle is moving or not and initialization of four tires can be also a problem as the driver does not know which tire is malfunctioning. Especially in the current discussions of existing technology and future technology, spare tire and replacement tires, switching of tires due to uneven wear can be an unsolved issue and need to be resolved, even thought the possible regulation has not finalized. It is the believed the final safety is the key to the drivers and the public citizens and new technology is needed. Short distance communications between the sensor in the tire and the initialization box on the body near the tire can provide one solution to this initialization, such as the technology provided by TRW. Radio-frequency identification (RFID) can also be a solution. Bluetooth bi-directional communications can also be used. However, cost can be an issue for both the RFID and bluetooth technology, especially when the TPMS is used in those emerging markets, where the legislation has not been in place to enforce the direct measurement of tire pressure and automobile end-users may be reluctant to use the system.

Accelerometers are widely used in automotive industry, particularly in airbag, antilock brake system (ABS) and roll-over tilt sensing. The present invention integrates a low cost, highly reliable accelerometer in a small single package with the pressure sensor, temperature sensor, ASIC chips, and battery voltage sensor, which monitor the operating condition of a vehicle. Thus, this novel system can initialize the TPMS, continuously monitor the tire pressure and temperature, and wheel motion intelligently. The inventors have done study on the interactions between tires and vehicle stability and found the tire over pressure and under pressure can also affect the dynamics and stability of the vehicle in roll over and in harsh motions. Monitoring the motion of each wheel/tire is as important as using the accelerometers as the vibration switch alone.

Miniaturization by integrating various sensors and their relevant ASIC chips is ideal and however it has been difficult due to the compatibility of semiconductor manufacturing processes and micromachining processes. CMOS compatible micromachining processes have to be developed. In our case, particularly, integrating pressure sensor, temperature sensor, transistors for LF device, and accelerometer sensor in one single die or a few dies, and their relevant ICs into one package with appropriate compact footprint and profile is desirable to the end users. The miniaturization can be realized based on MEMS (Micro-Electro-Mechanical-Systems) technology with the micromachining feature carried over from mature semiconductor industry. MEMS devices include airbag accelerometers, pressure sensors, optical switches, etc., most of which are fabricated using bulk micromachining or surface micromachining. Most existing pressure sensors used for tire pressure sensor are bulk micromachined. A disadvantage of such pressure sensors is that they do not have inherent overpressure protection so that the diaphragm may crack. In addition, the thickness and dimension of the diaphragm is difficult to control precisely by regular bulk micromachining. A low stress, silicon rich nitride (SiN) is useful to stop the etching so that the diaphragm can be controlled more precisely than the regular poly-silicon.

Packaging of MEMS devices is very important to device reliability and makes a large part (50 to 80%) of total cost. MEMS device package usually needs hermetic seal or dust protection lids. At the same time, pressure sensor needs an opening to the environment. One challenge and the difficulty in packaging MEMS devices may lower the fabrications yield, which will enhance the cost. In addition, there is a limited space in which the various components can be placed in assembly of the tire and tire rim, as well as integrating the sensor chip and the ASICs into the packaging or onto the board. Unbalance induced by a big sensor mass and large volume of the sensing device will cause more time and cost in adjusting the dynamic equipment of the tire and tire systems, potentially increasing cyclic stresses, thus reducing reliability and durability of the TPMS. Replacement of tires and switching of tires due to the uneven wear will cause big reliability, durability and liability problems for OEMs and TPMS vendors. There is a definite need for a more compact, multi-functional sensor and sensor system for new generation TMPS to satisfy both government regulations and safety of the driver and passengers in the vehicle.

### SUMMARY

The present system addresses all the above needs and difficulties. The present invention integrates a micromachined pressure sensor with a more precise dimension control. At the same time, this invention also uses low stress silicon rich nitride (SiN) to stop the back bulk micromachining process so that a controlled membrane can be achieved. The accelerometer can monitor the wheel motion and can accurately initialize the identification of tires involved, and the ASIC implements the signal conditioning and digitalize the sensor output, as well as integrating temperature and voltage sensing functions in the system.

The present invention integrates multi-functional MEMS devices in a plastic package with low-cost and high reliability, or these chips are placed directly on a board based chip on board (COB) without sacrificing the reliability of the new packaging. With appropriate selection of materials with minimum thermal mismatch, low stress bonding materials, and design for reliability and manufacturing accumulated by the inventors, the latter approach may provide more cost reduction with enhanced reliability for the whole system

### BRIEF DESCRIPTION OF THE DRAWINGS

FIG. 1 shows a cross-section view of the multi-functional sensor plastic package.

FIG. 2 shows the top view of the sensing component by plastic packaging in TPMS.

FIG. 3 shows the principle of a z-axis thermal accelerometer.

FIG. 4 shows the package of a three-axis thermal accelerometer.

FIG. 5 shows the bulk fabrication technology, with pressure sensor and accelerometer on the same die, both being piezoresistive in principle.

FIG. 6 shows the cross section view of the COB for integrated system, (a) wire bond form without silicon stack, (b) wire bond form with silicon stack, and (c) with Parylene as a cover coating.

FIG. 7 shows the wafer level packaging form of flip-chip bonding

FIG. 8 shows the function block of the ASIC.

FIG. 9 shows the reference voltage and temperature sensor.

FIG. 10 shows the schematic of the instrumentation amplifier.

### DETAILED DESCRIPTION

Embodiments described herein depict sensing part of a tire pressure monitoring system packaged in a single plastic package, or in a SiP (system in a package) which is directly mounted on the board.

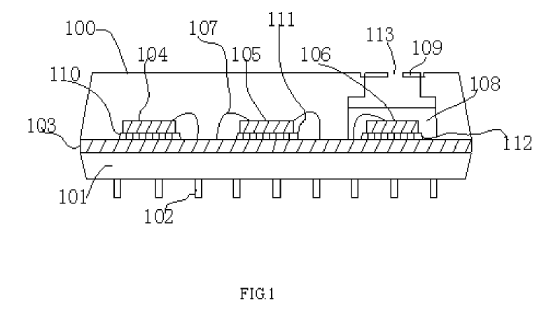

FIG. 1 shows a cross-section of the multi-chip plastic package module. The module integrates the TPMS sensing component in a single over-molded plastic package 100. The sensing component includes three chips: accelerometer104, ASIC 105, on which the temperature sensor is integrated, and pressure sensor 106. 101 is the plastic package body, which needs a specially designed mold. The resin transfer molding process can mold the accelerometer104, ASIC 105 and by molding compound. 102 are the pinouts. The plastic body may be epoxy based molding compound. The three chips are internally interconnected with each other via the leadframe 103. Wirebond 107 is used to form the interconnection between the chip pads and the leadframe. The three chips are attached to the leadframe using a special adhesive. The adhesive 110 used for accelerometer may be Ag filled glass adhesive. The adhesive 111 used for ASIC is epoxy adhesive, or some solder alloy. The adhesive 112 used for pressure sensor may be a low stress adhesive. The pressure sensor 106 is protected by a silicone gel 108. When filling the silicone gel, special care must be exercised, otherwise the MEMS part of the pressure sensor may be damaged. The gel is a low-modulus rubber, which will introduce little pressure error; however, the effect of the gel can be compensated for by circuit calibration or by design modeling based on nonlinear viscoplastic finite element modeling. Finally, the opening of the package is sealed by a steel cap 109 and with a small pressure hole 113.

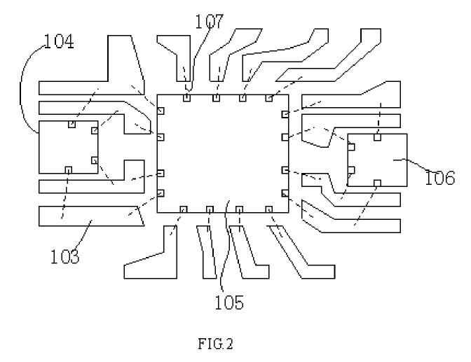

FIG. 2 shows the top view of the sensing component by plastic packaging in TMPS. Here accelerometer104, ASIC 105 and pressure sensor 106, wirebond 107 are on the same leadframe103.

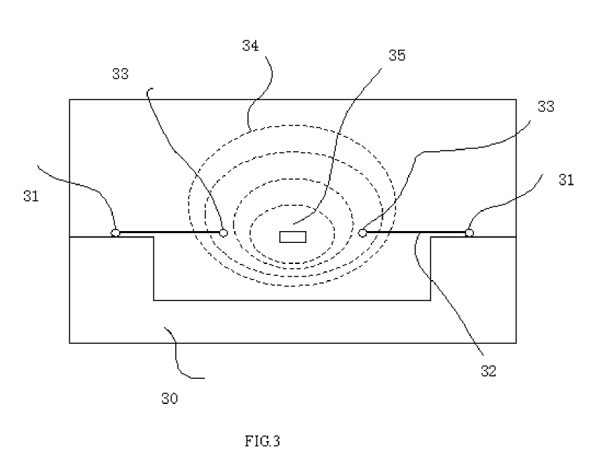

FIG. 3 shows the principle of a three-axis thermal accelerometer. The accelerometer is used for the TPMS wake-up from “power down” mode, the initialization mode, and the regular motion sensor when needed. When installing the sensor on each tire, the ASIC 105 will automatically send out the signal to the receiving unit near the sensor by LF sigal, which will be forwarded to the central control unit so that the initialization can be realized. “Power down” mode is used for saving battery energy when the wheel is not rotating, or when the angular velocity is too high. The acceleration signal is measured and compared with a threshold value for the system to wake up. If the acceleration is larger than the threshold, the device turns to “run” mode. Accelerometers usually need hermetic seal. Here, the accelerometer is used for monitoring the vehicle motion; the accelerometer may be based on piezoresisitive, capacitive or thermal principle. It is well known that the piezoresisitive behavior of doped silicon will be able to sense the resistor change due to the strain change induced by external pressure. Capacitance change is induced by the media, or gap, or area change between two plates or many plates.

Due to two-dimensional limit of CMOS structures, current thermal accelerometer can only provide sensitivity in x and y directions. FIG. 3 is a diagram of a thermal accelerometer. As can be seen, the isothermal contours are not vertically symmetrical. 30 is the silicon substrate, 35 is the heater and 34 is the hot air bubble. Thermocouple 32 is used to measure the temperature differences between the hot junction 33 and cold junction 31. Thermal gradient at the point of hot junction displays a vertical component, whose amplitude depends on the thermal asymmetry in vertical direction as well as position of hot junctions. The trench depth and the package height will influence the thermal asymmetry in vertical direction. The inventors use the common mode voltage of the thermocouple to extract the z-axis acceleration signal. This signal's sensitivity is rather smaller than the sensitivity of x and y axis, however, this is enough for the TPMS sensor to measure the radial acceleration for different work mode switch. By our delicate modeling work based on the principle of computational fluid dynamics (CFD) and experimental work, the sensitivity in the z-axis for even a planar thermal convention based accelerometer can achieve one sixth to one tenth sensitivity. This also offers the lowest cost accelerometer portion in this integrated sensor system.

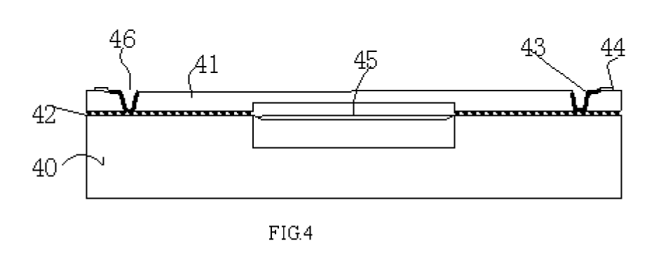

FIG. 4 shows the cross section view of the accelerometer package. Packaging at wafer level can reduce device size and the cost. Here, the three-axis accelerometer is packaged on wafer level. The sensor chip 40 and the cover chip are mated together by glass frit 42. 45 is the heater of the thermal accelerometer (for thermal based accelerometer sensor). To supply enough space for the air bubble, both wafers are etched with a depth of about 300 microns using plasma etching. The glass frit used here has a thermal coefficient of expansion similar to that of silicon, therefore, there will be no major thermal mismatch between chip and package. Thermal accelerometer is low in cost and with high reliability. In this way, the introduced stress in the accelerometer is very small. A 15 microns thick glass frit was applied on the sensor wafer 40 using a screen printer. One advantage of using glass frit is to comprise the circuitry induced uneven surface. Then the two wafers are bonded together at a temperature of 400 C. The electrical signals come out from the vias 46 on the cover chip, which are Cu metallization 43. The etching process of vias are made in a potassium hydroxide (KOH) solution. The aluminum (Al) pads are deposited on the cover chip, which are used for interconnection by wire bond or flip-chip when it is attached on a same leadframe with pressure sensor and ASIC.

To reduce the cost and increase the reliability, bulk pressure sensor can also be used for TPMS sensing system, pressure sensor and z-axis accelerometer are fabricated on a single die and assembled in a single package later.

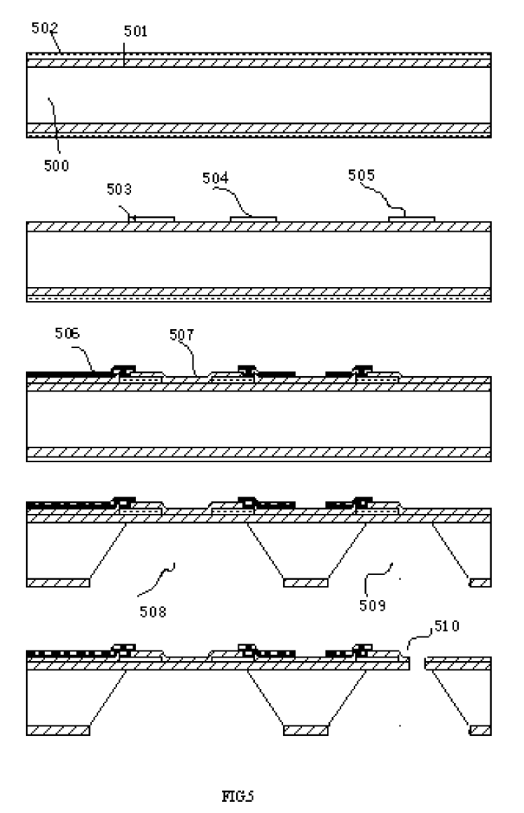

FIG. 5 shows the bulk fabrication technology, with pressure sensor and accelerometer on the same die, both are piezoresistive.

In FIG. 5A, very uniform silicon nitride 501 and polysilicon thin films 502 can be deposited on silicon wafer 500. A silicon nitride layer is deposited on the wafer back to define the etch windows later when doing rear bulk micromachining. The polysicilon layer may be deposited using conventional technology, such as LPCVD (low pressure chemical vapor deposition). In FIG. 5B, piezoresistors 503, 504, and 505 are formed. The resistors may be deposited and patterned as mentioned above. Piezoresistors 503 and 504 are used for pressure sensor, and piezoresistor 505 is used for accelerometer.

In FIG. 5C, another silicon nitride layer 507 is deposited with a thickness of 0.1 microns for passivation layer. Metal layer 506 for electrical signal is also deposited and patterned.

In FIG. 5D, the anisotropic etching step from the rear of the wafer is performed in a KOH solution to form the diaphragm, 508 and 509 are the etched cavity. During the etching step, the wafer front is protected from the etching solution by a mechanical housing.

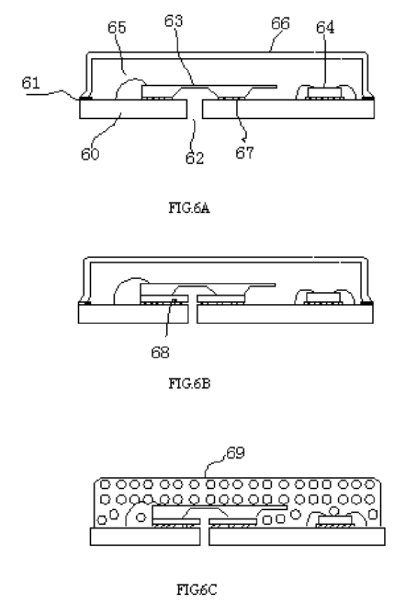

In FIG. 5E, KOH solution is also used to free the proof mass of the accelerometer from front side of the wafer. FIG. 6 shows the cross section view of TPMS sensor packaged in chip on board (COB). Depending on the design and the requirements of zero point drifting, hysteresis, cycling drifting, glass or silicon stack may be needed. Wire bonding without stack (FIG. 6A), wire bonding with stack (FIG. 6B) will be discussed below.

The TPMS sensor is packaged using chip-on-board (COB) to reduce the manufacturing cost and reduce the size. Wire-bond COB packaging is commonly employed in low-cost multi-chip-module applications such as in watches due to the thermal mismatch between the organic board and chips. However, as pointed out by the first inventor in American Society of Mechanical Engineering Congress of 2003, the hysteresis, cycling drifting, zero point shifting can be minimized either by low stress die attach or a silicon/glass stack with appropriate thickness. This forms the basis for new packaging of COB for the TPMS system. In addition, current 20% to 25% pressure drop is big for a 30 psi regular tire pressure sensor. It is believed that the COB packaging can offer accurate enough sensor for the TPMS with low cost. In FIG. 6, 60 is the substrate for the COB package, which is a printed circuit board (PCB) made of FR4. The substrate provides many advantages for electronic packaging, such as low-cost, low dielectric constant, and good electrical insulation. Ceramic substrate may also be used in some critical applications. When doing the PCB layout, via 62 is used for pressure inlet. The copper trace and solder mask on the PCB are designed to provide the bonding pads and interconnections between MEMS sensor 63 and ASIC 64. Adhesive resin 67 not only attaches the chip on the board, but also compensates for the thermal mismatch due to the different coefficients of thermal expansion for the chip and substrate. Both chips are connected to the substrate by low-cost wire-bond. Finally, the whole board is hermetic sealed by a metal cap 66. The metal cap 66 and the substrate 60 are mated by adhesive 61.

FIG. 6B shows wire bonding form with the silicon stack is for minimizing zero point signal drifting, cycling signal drifting, and hysteresis from low to high temperature cycling. 68 is the silicon stack, which is bonded with the sensor wafer using glass frit, the fabrication process is similar to the accelerometer bonding process shown above.

FIG. 6C shows the COB package coated by polymer 69 as an option, the polymer may be parylene or other harder polymer material. After die attachment and wire bonding, the polymer is applied and then the whole chip is cured in the oven.

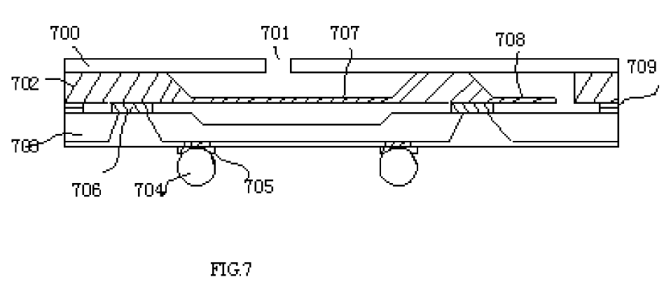

FIG. 7 shows the wafer level package of the TPMS sensors. The bulk micromachined sensors 702 are protected with a perforated glass wafer 700, on which there is a pressure inlet 701, and stacked on a silicon wafer 703. The micromachined sensors here include pressure sensor 707 and z-axis accelerometer 708. The accelerometer here is hermetically packaged. The sensor wafer 702 and the stack wafer 703 are bonded together with gold 709 as intermediate layer. The sensor wafer and the cap glass wafer 700 are mated together by anodic bonding. The sensor wafer is firstly sputtered with a layer of gold of about 0.1 microns in thickness. The sputter coating operation is carried out in a PVD (physical vapor deposition) system. A lithographic process is employed to define the plating area. Gold electroplating is then performed to build up a layer of gold with a height of 1 microns. After the two wafers are cleaned, they are bonding together at eutectic temperature 400 C. The glass wafer700 used here is Pyrex 7740 with a flatness better than 5 microns. After alignment between the glass wafer and the sensor wafer, anodic bonding is carried out by applying a voltage 600V on the two wafers. The under-bump metallurgy (UBM) 705 consists of Ti—W and Cu. The UBM and solder bump704 are fabricated by electroplating. After the wafer level package, the pressure sensor and the accelerometer can be mounted on the print circuit board by flip-chip bonding.

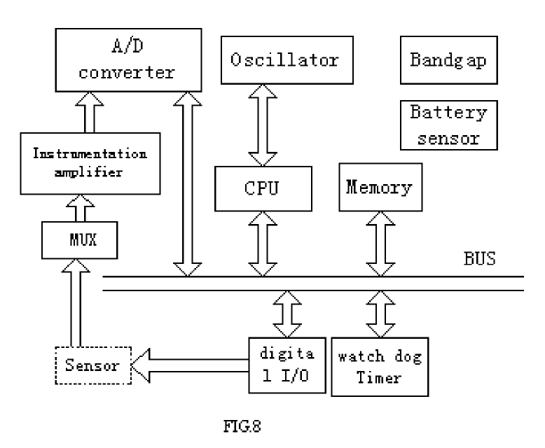

FIG. 8 shows the function block of the ASIC. The mixed signal ASIC implements signal conditioning and digitalize the sensor output to RF module. The digital part is designed using standard Verilog HDL language. The analog part is full-customer designed, and they are merged together when chip is done with layout. The ASIC is powered by one 8 bits CPU. Both the acceleration signal and pressure signal are supplied as input to the MUX block of the ASIC, the selection of the input can be controlled by the digital I/O of the ASIC. The instrumentation amplifier operates in a differential mode with programmable gain, in order to trim the MEMS device. The ADC is implemented as a first order Sigma-Delta ADC. The Sigma-Delta ADC modulator is a fully-differential switched-capacitor circuit that is clocked at the on-chip oscillator. The battery sensor gives out a voltage proportional to the battery voltage, so that the system can give an indicator when the battery is used up. The pressure sensor needs trimming for a higher yield when manufacturing. The control registers are stored in the on-chip EEROM after the pressure is calibrated, following is the definition of the 19-bit control registers:

B0. MASTER—The value stored in this bit is meaningless, unless the associated fuse is blown. Once the fuse is blown, the serial interface is disabled, so that no further programming can take place.

B1. REF1—This control bit is provided to allow observability of the bandgap reference voltage during trimming.

B2-B4. BG[0:2]—These 3 bits are used to trim the output voltage, and hence temperature coefficient of the bandgap reference. The control word is interpreted as a 2's complement number, with all 0's representing the nominal trim setting. Each step corresponds to a 1% change in the bandgap output voltage.

B5-B8 TOFF[0:3]—These 4 bits are used to trim the offset of the temperature sensor output. The control word is interpreted as a 2's complement number with all 0's representing the nominal trim setting. The temperature sensor offset is adjustable in steps equal to 1% of full scale.

B9-B12 Ex[0:3]—These 4 bits are used to adjust the excitation voltage on the piezoresistor by trimming the output resistor. The control word is interpreted as a 2's complement number.

B13-B18 AOFF[0:5]—These 6 bits are used to trim the offset of the pressure sensor output. The control word is interpreted as a 2's complement number with all 0's representing the nominal trim setting. The pressure sensor offset is adjustable in steps equal to 3% of full scale.

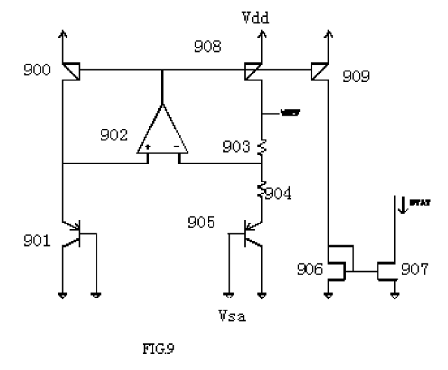

FIG. 9 shows the reference voltage and temperature sensor integrated on the ASIC. The bandgap circuit includes an OpAmp 902; p-channel transistors 900,908,909; bipolar junction transistors 901 and 905, resistors 903 and 904 to provide the reference voltage VREF. The voltage reference is provided on-chip to allow for supplying independent sensor sensitivity and offset reference, and has a value of about 1.25 volts. A natural by-product of the bandgap reference is a PTAT (proportional to absolute temperature) current. The PTAT current circuit includes a current mirror comprising the n-channel transistors 906 and 907. The PTAT is used as the die temperature sensor, which can be used for temperature compensation of the pressure sensor signal.

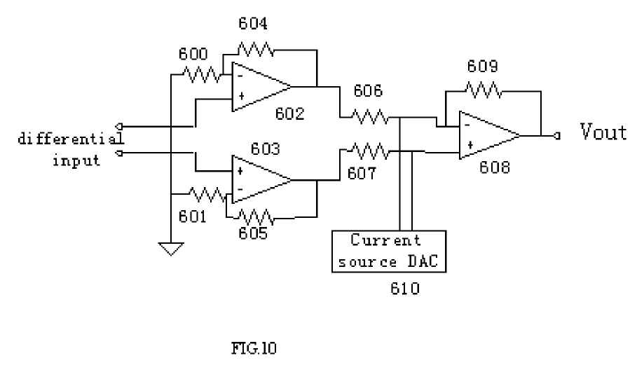

FIG. 10 shows the schematic of the instrumentation amplifier. The purpose of this instrumentation amplifier is to provide analog output voltage that is proportional to the pressure. The instrumentation amplifier includes a differential input stage comprising an operational amplifier (OpAmp) 602, an input resistor 600 and a feedback resistor 604, and an operational OpAmp 603, an input resistor 601 and a feedback resistor 605. The second stage of the instrumentation amplifier includes an OpAmp 608, input resistors 606, 607, and a feedback resistor 609, and current source DAC 610. The current source is used to adjust the offset, resistor 609 is an adjustable resistor, which is used to trim the gain of the signal.

While the present invention has been particularly shown here and described with reference to exemplary embodiments thereof, it will be understood by those of ordinary skills in the art that various changes in form and details may be made therein without departing from the spirit and scope of the present invention as defined by the following claims.

What is claimed is:

1. An integrated multi-functional sensing system for tire pressure monitor system (TPMS), comprising: a pressure sensor, an accelerometer that monitors vehicle motion, LF transistors for initiazation of tire locations, and an ASIC that implements signal conditioning and digitalizes pressure output.

2. The monolithic chip of claim 1 is monolithically integrated or packaged with integrated circuit (IC) chips in a single plastic body, which has a specially designed mold and resin transfer molding process. The MEMS part of the pressure sensor is protected by silicon gel.

3. The pressure sensor of claim 1 can be fabricated using bulk micromachining. Multi-function features can be fabricated on the same die for TPMS sensing, with sensors being based on MEMS.

4. An accelerometer incorporated in claim 1 is used to determine centrifugal acceleration (z-axis) of the rotating wheel, used for the TPMS sensor wake-up from “power down” mode, or when the velocity of the vehicle is higher than certain speed threshold, and used for the regular motion measurement.

5. The accelerometer of claim 3 is fabricated with CMOS compatible MEMS. The accelerometer is a z-axis thermal accelerometer wafer level packaged by glass frit.

6. The z-axis signal in the accelerometer of claim 5 is extracted from the common mode voltage of the z, y axis signals. The z-axis signal is used for the TPMS sensor to respond from power down mode.

7. The chip of claim 4 can also be a bulk pressure sensor and accelerometer can be fabricated on the same die, both sensors are piezoresistive in nature.

8. The MEMS sensors of claim 3 are packaged in chip-on-board (COB) with the ASIC as an option, the substrate for the COB package may be FR4 material or ceramic substrate, according to the application.

9. COB in claim 8 can be in terms of three forms in claim 6: wire bonding without glass or silicon stack, wire bonding with glass or silicon stack, and flip-chip and wafer bonded with the glass or silicon stack.

10. Wire bonding form without glass or silicon stack in claim 9 is for the low cost, with certain tolerance of zero point signal drifting, cycling signal drifting, and hysteresis from low temperature to high temperature.

11. Wire bonding form with the glass or silicon stack with certain height in claim 9 is for minimizing zero point signal drifting, cycling signal drifting, and hysteresis from low to high temperature.

12. Packaging form by flip-chip and wafer bonded with the glass or silicon stack in claim 9 is also for minimizing zero point signal drifting, cycling signal drifting, and hysteresis from low to high temperature.

13. Bonding layers or bumps above the PCB in claim 9 can be in soft adhesives or solders to minimize the additional packaging stresses on the sensing elements.

14. COB in claim 7 can be protected by a metal or ceramic cap or coated by a polymer layer such as parylene, etc.

15. The ASIC of claim 7 implements signal conditioning and trimming of the pressure sensor. The ASIC compensate the pressure sensor signal to a total error of less than ±3% of FSO (Full Scale Output) with a temperature of minus 40 degrees to 125 degrees required by automotive industry. The ASIC is a mixed signal chip, the digital part of the chip is implemented by Verilog HDL language. The main part of the analog signal is an instrumentation amplifier.

16. The amplifier in the ASIC of claim 15 is a programmable amplifier, the offset and gain can be trimmed by polysilicon fuses, both have a resolution of 6 bits.

17. A temperature sensing function is integrated on the ASIC of claim 7. The temperature sensor is used for temperature compensation of pressure sensor, as well as for reporting the temperature of the tire.

18. A battery voltage sensing function is integrated on the ASIC of claim 7 when the battery is exhausted or is off. The sensor will provide a warning indication to the system.
